(19) United States
(12) Patent Application Publication
(10) Pub. No.: US 2003/0174240 A1
(43) Pub. Date: Sep. 18, 2003

(54) Mobile telephone

(75) Inventors: Jyoji Wada, Yokohama-shi (JP); Takashi Kusakari, Yokohama-shi (JP); Kazushige Tamura, Yokohama-shi (JP)

Correspondence Address: PEARNE & GORDON LLP, 526 SUPERIOR AVENUE EAST, SUITE 1200, CLEVELAND, OH, 44114-1484, US

(73) Assignee: Matsushita Electric Industrial Co., Ltd.

(21) Appl. No.: 10/375,553

(22) Filed: Feb. 27, 2003

(30) Foreign Application Priority Data
Feb. 28, 2002 (JP) P. 2002-053872

(51) Int. Cl. H04N 5/225

(52) U.S. Cl. 348/374; 455/575.1

(57) ABSTRACT

A mobile telephone having a first body and a second body which are foldably coupled via a hinge mechanism 2, a wide-angle lens for obtaining a wide-angle image, a telephoto lens for obtaining an enlarged image, and an image pickup element installed in an image focusing place. The mobile telephone includes a slide mechanism for not only causing the enlarged image to be input to the image pickup element provided in the second body through the telephoto lens provided in the first body with the mobile telephone folded but also sliding the image pickup element in the second body in response to the pivotal action of the hinge mechanism when the first body and the second body are unfolded so as to cause the wide-angle image to be input to the image pickup element through the wide-angle lens provided in the second body.

### BACKGROUND OF THE INVENTION

1. Field of the Invention

The present invention relates generally to mobile telephones and more particularly to a mobile telephone designed to have a common camera portion for use in obtaining enlarged images with a telephoto lens as well as photographing scenery with a wide-angle lens.

2. Description of the Related Art

With the broad diffusion of mobile telephones and the progress for making mobile telephones more multifunctional, there have been proposed those carrying private information so that payment may be made by mobile telephones instead of credit cards in recent years. However, such a way of using mobile telephones also makes it necessary to devise countermeasures against illegal use by strangers.

In Japanese Patent Publication No. 2001-92786 and Japanese Patent Publication No. 2000-307715, for example, mobile telephones carry out the functions of identifying individuals by the use of the iris, fingerprints and so forth in order to make each mobile telephone judge whether its holder is a rightful owner, whereby any person other than the rightful owner is prohibited from using the mobile telephone.

A method of identifying an individual by means of the iris is considered to come into general use in future as it is only necessary for a mobile telephone to be equipped with an electronic camera for taking a photograph of the iris. Nevertheless, the iris imaging camera has to be a telephoto camera having a long focal length because such a camera is needed to take a photograph of the ripple of the iris. Moreover, since the most distinct iris image is obtained in the vicinity of near infrared light, a visible-light cutting filter has to be mounted over a lens.

On the other hand, mobile telephones equipped with wide-angle cameras are increasingly employed so that the mobile telephones are used as visual telephones and to take photographs of scenic images that can be transmitted to called parties. The wide-angle camera has a focal length shorter than that of the telephoto camera and more distinct images are obtained by mounting over a lens an infrared-light cutting filter for passing visible light therethrough but cutting infrared light.

Thus, the telephoto camera for imaging the iris and the wide-angle camera for taking in scenic images are substantially functionally contrary to each other and it is difficult to house two of the cameras within the body of a small mobile telephone. Therefore, there develops a demand for structuring a mobile telephone in which camera portions for common use are formed into a common camera portion as much as possible. Further, mounting a lens having a zooming function in such a mobile telephone also presents a problem arising from an increase in the manufacturing cost.

### SUMMARY OF THE INVENTION

An object of the invention is to provide a low-cost mobile telephone having a common camera portion wherein a telephoto camera for imaging the iris is usable in common with a wide-angle camera for taking photographs of scenery and so on.

A mobile telephone arrangeable in a plurality of forms, comprises an image pickup unit for forming images and a switching unit for switching focal lengths toward the image pickup unit with the accompaniment of changing one form to another. As the focal length of the image pickup unit is adjustable with the accompaniment of the transformation, a common image pickup unit becomes usable with a plurality of lenses different in focal length.

The object of the invention is made accomplishable by a folding mobile telephone comprising a first body and a second body which are foldably coupled via a hinge mechanism, a wide-angle lens for taking in a wide-angle image, a telephoto lens for taking in an enlarged image, and image pickup unit installed in an image focusing place, further including a slide mechanism for not only causing the enlarged image to be input to the image pickup unit provided in the second body through the telephoto lens provided in the first body with the mobile telephone folded but also sliding the image pickup unit in the second body in response to the pivotal action of the hinge mechanism when the first body and the second body are unfolded so as to cause the wide-angle image to be input to the image pickup unit through the wide-angle lens provided in the second body.

When the enlarged image is obtained, the sum of the thickness of the first body and the thickness of the second body is utilizable as the focal length of the lens with the folding mobile telephone folded, whereby the telephoto lens can be installed in the mobile telephone. When the mobile telephone is used as a wide-angle camera, a wide-angle lens having a short focal length is made usable by mounting the wide-angle lens in the second body equipped with the image pickup unit without loading an expensive lens having a zooming function therein.

Preferably, the telephoto lens and a visible-light cutting filter may be juxtaposed to each other according to the invention. Thus, a clear iris image is obtainable when the iris image is obtained with the telephoto lens.

More preferably, the slide mechanism has a pinion rotating as the hinge mechanism pivots and a rack member sliding as the pinion rotates according to the invention. Thus, the image pickup unit can be slid with a simple mechanism and is manufacturable less costly.

More preferably, the slide mechanism has a first stopper member for stopping the image pickup unit in the optical axis position of the telephoto lens and a second stopper member for stopping the image pickup unit in the optical axis position of the wide-angle lens according to the invention. Thus, the presence of the stopper members ensure the positioning of the image pickup unit, so that good images are obtainable.

More preferably, the mobile telephone includes a control unit for holding data on the characters of the registered iris, permitting the use of the mobile telephone when the control unit decides that the data on the characters of the iris obtained by reducing an iris image received as the enlarged image to an numeral conforms to the data on the characters of the registered iris and prohibiting the use thereof when the control unit decides that the data on the characters of the iris obtained thereby differs from the data on the characters of the registered iris according to the invention. Thus, illegal use of the mobile telephone is prevented.

More preferably, the mobile telephone has a mechanical lock mechanism or an electrical lock mechanism for permitting the first body and the second body to be unfolded when the control unit permits the use of the mobile telephone. Thus, not only the illegal use but also the mechanical operation of the mobile telephone is prevented.

The mobile telephone according to the invention is characterized by having a wide-angle lens, a telephoto lens, a image pickup element, a lens moving mechanism for lining up the image pickup element and the wide-angle lens when image formation is conducted through the wide-angle lens and lining up the image pickup element and the telephoto lens when the image formation is conducted through the telephoto lens, and an image pickup element positioning mechanism for placing the image pickup element at the image forming position of the wide-angle lens when the image formation is conducted through the wide-angle lens and placing the image pickup element at the image forming position of the telephoto lens when the image formation is conducted through the telephoto lens.

With the arrangement above, a common camera portion for use in the installation of not solely a telephoto camera but also a wide-angle camera can be provided, so that two of the cameras can be mounted in a small body of a mobile telephone less costly. Moreover, two kinds of telephoto and wide-angle images can be taken without using a lens employing a costly zooming mechanism.

Preferably, an authenticating function for permitting the use of the mobile telephone only when the data on the characters of the iris out of the iris image taken in from the telephoto lens conforms to the data on the characters of the registered iris. This arrangement improves the safety of the mobile telephone when the mobile telephone is used with individual information and so forth stored therein.

### BRIEF DESCRIPTION OF THE DRAWINGS

FIG. 1 is an external view of a folding mobile telephone in a folded condition according to a first embodiment of the invention;

FIG. 2 is a vertical sectional view of the principal part of the folding mobile telephone in the folded condition according to the first embodiment of the invention;

FIG. 3 is a vertical sectional view of the principal part of the folding mobile telephone 1 in an unfolded condition according to the first embodiment of the invention;

FIG. 4 is a construction diagram of a slide mechanism according to the first embodiment of the invention;

FIG. 5A is a graph showing the relation between the quantity of extension-contraction of a coil spring (buffer) member for use in the slide mechanism of the mobile telephone and the folding angle Θ of the mobile telephone according to the first embodiment of the invention;

FIG. 5B is a graph showing the relation between the movement of the slide plate and the folding angle Θ of the mobile telephone according to the first embodiment of the invention;

FIG. 6 is a schematic side view of a mobile telephone according to a second embodiment of the invention;

FIG. 7 is a perspective view of a camera portion mounted in the mobile telephone according to the second embodiment of the invention;

FIG. 8 is a side view of the camera portion when the telephoto lens of the mobile telephone is used for forming images according to the second embodiment of the invention; and

FIG. 9 is a side view of the camera portion when the wide-angle lens of the mobile telephone is used for forming images according to the second embodiment of the invention.

### DETAILED DESCRIPTION OF THE PREFERRED EMBODIMENT

Embodiments of the invention will now be described by reference to the drawings.

(Embodiment 1)

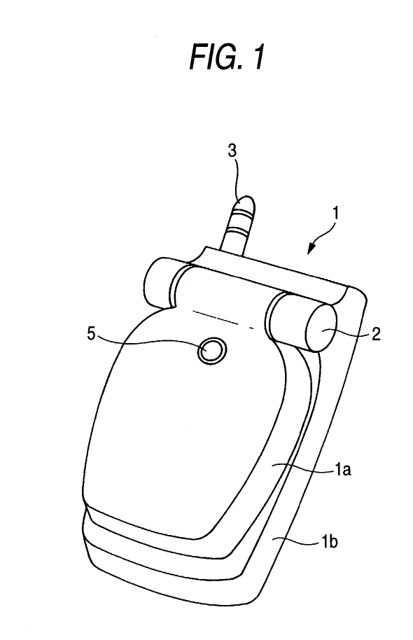

FIG. 1 is an external view of a folding mobile telephone in a folded condition according to a first embodiment of the invention. A folding mobile telephone 1 is so structured that a first body 1a and a second body 1b are coupled together with a hinge mechanism 2 for pivoting the first body 1a. An antenna 3 is projected from the second body 1b and used for transmitting and receiving information for authentication of transmitting-receiving signals and data on the characters of the iris or image data such as photographs. The antenna 3 may be projected from the first body 1a or incorporated therein.

According to this embodiment of the invention, a liquid crystal display is provided on the first body 1a and a keyboard operating portion is provided on the second body 1b. The liquid display and the keyboard operating portion are put together in the folded condition, whereby both of them are hidden from view and in this folded condition, the folding mobile telephone is usable as a telephone and capable of performing only its receiving function.

When the calling operation is performed and when the credit card function is utilized, the iris image of the owner is picked up through a window 5 in the exterior of the first body 1a with the mobile telephone 1 folded up. The mechanically locked condition of the mobile telephone 1 is canceled only when the iris image thus picked up is authenticated as that of a rightful owner and then the mobile telephone 1 is allowed to be unfolded. As the electronic lock is freed, inputting various data via the keyboard operating portion is permitted.

The mechanically locked condition in this case means a condition in which the mobile telephone is not unfolded because of a lock mechanism. In the case of a folding mobile telephone folded and unfolded by means of an electric motor, the mobile telephone is locked in the folded condition by setting the electric motor inoperable.

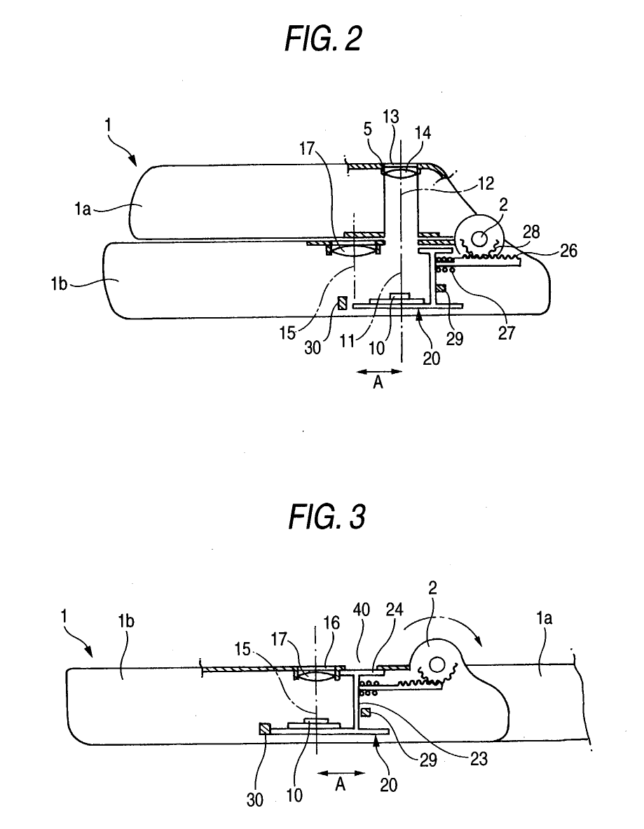

FIG. 2 is a vertical sectional view of the principal part of the folding mobile telephone 1 in the folded condition as shown in FIG. 1; and FIG. 3, a vertical sectional view of the principal part of the folding mobile telephone 1 in an unfolded condition. In the folding mobile telephone 1 with an iris authenticating function according to this embodiment of the invention, an image pickup element (CMOS may also be used though CCD is employed in this example) 10 is mounted on a slide mechanism 20, which will be described in detail later, in the second body 1b and used for picking up the iris, scenery and so forth. The slide mechanism 20 is caused to slide in the direction shown by a double headed arrow A in accordance with the folding and unfolding of the mobile telephone 1; iris images are formed with the mobile telephone 1 folded up, whereas scenic images are formed with the mobile telephone 1 unfolded.

In the folding mobile telephone 1 in the folded condition (see FIG. 2), an iris imaging optical path 11 in the second body 1b formed ahead of the image pickup element 10 and an iris imaging optical path 12 communicating with the window 5 in the first body 1a stand in a row and the iris image formed through the window 5 is made to focus into an image on the image pickup element 10.

A visible-light cutting filter 13 is embedded in the window 5 and a telephoto lens 14 is fixedly provided right under the filter 13. In other words, the sum of the thickness of the first body 1a and the thickness of the second body 1b is utilized as the focal length of the telephoto lens 14 when an iris image is picked up according to this embodiment of the invention.

When the folding mobile telephone 1 is unfolded to bring on the condition of FIG. 3, the slide mechanism 20 is caused to slide by a pinion rack provided to the hinge mechanism 2 as described later, so that the image pickup element 10 is moved to a scenery imaging optical path 15 adjoining to the iris imaging optical path 11 in the second body 1b.

An infrared-light cutting filter 16 is embedded in an opening in the second body 1b of the scenery imaging optical path 15 and a wide-angle lens 17 is fixedly provided right under the infrared-light cutting filter 16. In other words, the thickness of the second body 1b is utilized as the focal length of the wide-angle lens 17 when scenic images are picked up according to this embodiment of the invention.

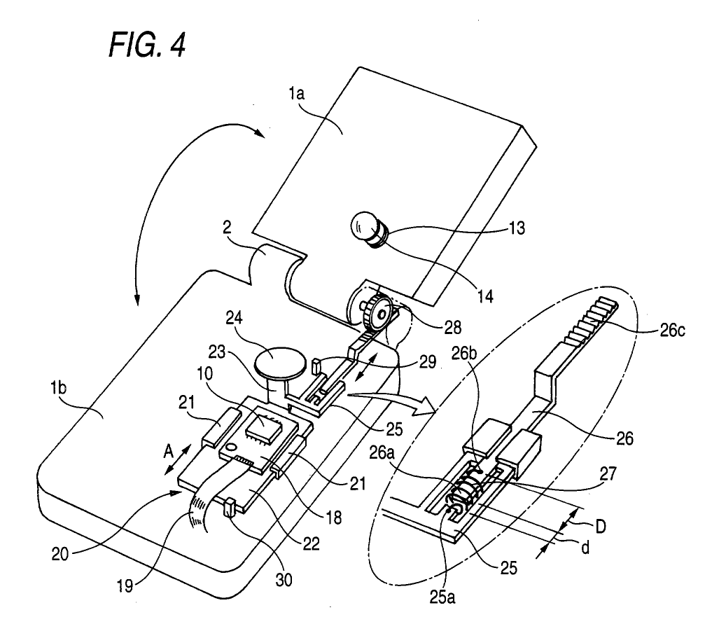

FIG. 4 is a construction diagram of the slide mechanism 20. The slide mechanism 20 provided in the second body 1b has a slide plate 22 to be slid in the direction shown by the double headed arrow A (i.e., directed across the iris imaging optical path 11 and the scenery imaging optical path 15) under the control of guide members 21. A printed circuit board 18 with the image pickup element 10 mounted thereon is placed and held on the top of the slide plate 22. The printed circuit board 18 and the control unit (not shown) of the mobile telephone 1 are connected by a flat cable 19.

A projection member 23 bent toward the first body 1a with the mobile telephone 1 folded is extendedly provided on the side of the hinge mechanism 2 of the slide plate 22 and a shield portion 24 for blocking up the opening 40 (see FIG. 3) of the iris imaging optical path 11 with the mobile telephone 1 unfolded is provided in the front end portion of the projection member 23.

A U-shaped rack supporting portion 25 is integral with and mounted onto the projection member 23. The U-shaped open end of the rack supporting portion 25 is directed to the hinge mechanism 2 and one end portion 26a of a rack member 26 extending in the direction of the hinge mechanism 2 is inserted into the U-shaped portion from the open end of the rack supporting portion 25.

A coil spring member 27 is provided between the rack supporting portion 25 and the rack member 26. One end portion of the coil spring member 27 is coupled to the U-shaped base portion 25a of the rack supporting portion 25 and the other portion of the coil spring member 27 is coupled to a spring coupling portion in a place separated by a required distance D from the base edge face on the side of the one end portion 26a of the rack member 26.

The coil spring member 27 functions as a buffer member and while the coil spring member 27 is in an unloaded condition, the edge face of the one end portion 26a of the rack member 26 is separated by a required distance d from the edge face of the base portion 25a of the rack supporting portion 25. Even if a load is applied to the coil spring member 27 when the mobile telephone 1 is folded or unfolded, both edge faces never abut against each other.

More specifically, when the rack member 26 pulls the slide plate 22 toward the hinge mechanism 2, the slide plate 22 is pulled via the coil spring member 27, whereas when the rack member 26 pushes the slide plate 22, the slide plate 22 is pushed via the coil spring member 27, whereby no shock is applied to the image pickup element 10.

A tooth face 26c is provided on the other end side of the rack member 26 and a pinion 28 meshing with the tooth face 26c is coupled to the rotary shaft of the hinge mechanism 2. Thus, the pinion 28 rotates clockwise as shown in FIG. 4 to push down the rack member 26 in a direction opposite to the hinge mechanism 2 as the mobile telephone 1 unfolds, whereas the pinion 28 rotates counterclockwise to pull the rack member 26 toward the hinge mechanism 2 as the mobile telephone 1 folds.

In the mobile telephone 1 according to this embodiment of the invention, a slide-plate stopping member 29 contacting the slide plate 22 is provided in the second body 1b so that the image pickup element 10 stops at the optical axis position of the iris imaging optical path 11 when the slide plate 22 is pulled by the rack member 26 via the coil spring member 27 with the mobile telephone 1 folded.

Further, a slide-plate stopping member 30 contacting the slide plate 22 is provided in the second body 1b so that the image pickup element 10 stops at the optical axis position of the scenery imaging optical path 15 when the slide plate 22 is pushed by the rack member 26 via the coil spring member 27 with the mobile telephone 1 unfolded.

Each of the slide-plate stopping members 29 and 30 is covered with an elastic member such as rubber so as to prevent a shock from being applied to the image pickup element 10 when brought into contact with the slide plate 22.

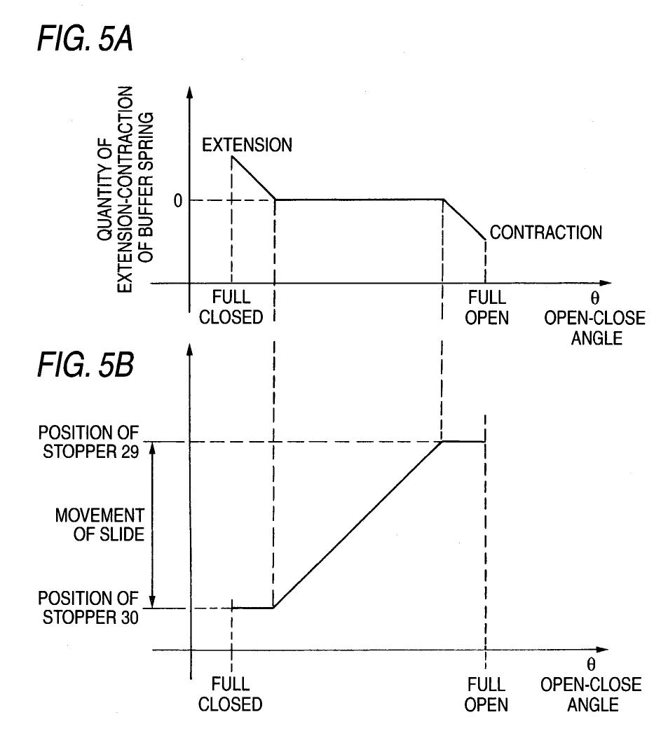

FIG. 5A is a graph showing the relation between the quantity of extension-contraction of the coil spring (buffer spring) member and the unfolding angle Θ of the mobile telephone 1; and FIG. 5B, a graph showing the relation between the movement of the slide plate 22 and the unfolding angle Θ thereof.

With the mobile telephone 1 completely folded, the rack member 26 pulls up the slide plate 22 toward the hinge mechanism 2 to bring the slide plate 22 into contact with the stopper member 29, so that the position of the image pickup element 10 is fixed by the force of the coil spring member 27 (with the coil spring member 27 elongated) to the iris imaging optical path 11.

When the mobile telephone 1 starts being unfolded, the rack member 26 is pushed down in the direction opposite to the hinge mechanism 2 and the coil spring member 27 is caused to contract and assumes the unloaded condition. The quantity of extension-contraction of the coil spring member 27 changes to zero until the mobile telephone 1 is unfolded to a certain degree. When the mobile telephone 1 is unfolded further, the position of the image pickup element 10 moves to the scenery imaging optical path 15 and the slide plate 22 is brought into contact with the stopper member 30. When the mobile telephone 1 is completely unfolded, the coil spring member 27 assumes a contracted condition and the position of the slide plate 22, that is, the image pickup element 10 is fixed by the force of the coil spring member 27 to the scenery imaging optical path 15.

With the folding mobile telephone 1 arranged as described above, the owner of the mobile telephone 1 carries the mobile telephone 1 in the folded condition and adjusts the owner's position so that the owner's iris is photographed through the window 5. Then the owner's iris is photographed by pressing a switch (not shown). When it is decided by the control unit installed in the mobile telephone 1 that the iris image conforms to what has been registered in the mobile telephone 1 beforehand, the mechanical lock mechanism (or electrical lock mechanism) (not shown) of the hinge mechanism 2 is freed and the mobile telephone 1 can be unfolded. Simultaneously, the electronic lock mechanism is freed and thereby, keyboarding is made possible.

In case that a stranger attempts to make a fraudulent use of the mobile telephone 1, because data on the characters of the iris resulting from numerically expressing the iris image picked up (e.g., numeric data in the form of a 01 binary code deriving from an iris pattern) differs from pre-registered data on the characters of the iris of a user (rightful owner), the stranger is not allowed to even unfold the mobile telephone 1. Even though the mobile telephone 1 is unfolded forcibly, the electronic lock is not freed and nothing can actually be input by keyboarding, so that the mobile telephone 1 remains inoperable.

With the mobile telephone 1 unfolded, by tripping the switch (not shown), it is possible imaging scenery using the wide-angle lens 17 and also taking in a self-portrait by directing the wide-angle lens 17 to oneself so as to operate the mobile telephone 1 as a visual telephone while sending the self-portrait to a called party.

Thus, according to this embodiment of the invention, the portions for common use including the iris imaging camera function and the scenery image camera function are formed into one common portion, two kinds of cameras can virtually be installed less costly in one mobile telephone.

Although the opening 40 of FIG. 2 and the opening of the iris imaging optical path 12 in parallel thereto are defined as solely ‘holes’ in order to improve the transmittance of light, it may also be arranged to cover these ‘holes’ with transparent plates such as glass plates. Moreover, though the image pickup element 10 is provided in the second body 1b with the telephoto lens 14 provided in the first body 1a, the same effect is made achievable by conversely providing the image pickup element 10 in the first body 1a with the telephoto lens 14 provided in the second body 1b.

(Embodiment 2)

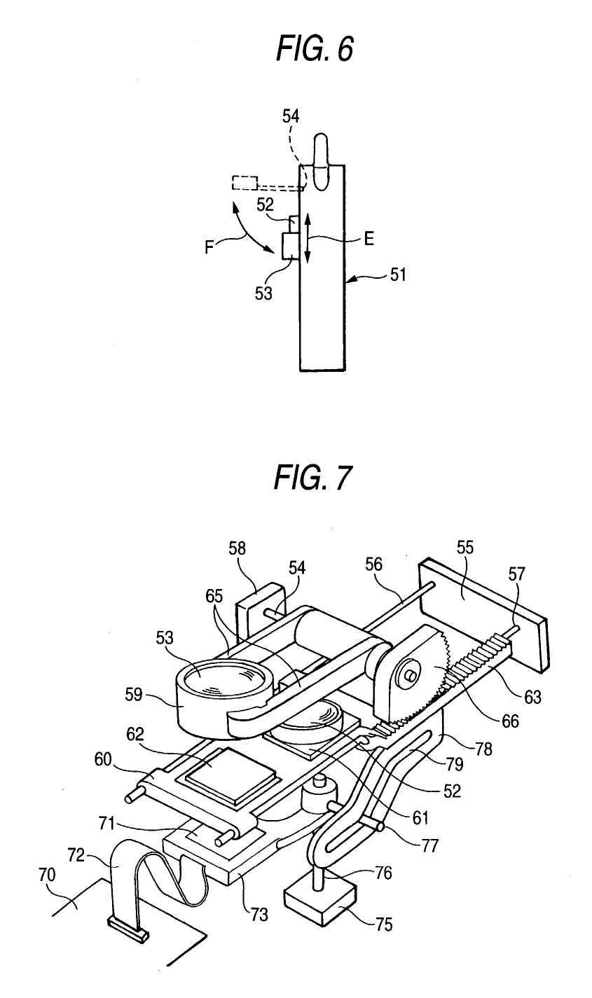

FIG. 6 is a schematic side view of an unfolding mobile telephone according to a second embodiment of the invention. A wide-angle lens 52 and a telephoto lens 53 are mounted in a mobile telephone 51. The wide-angle lens 52 is slidable (as shown by a double headed arrow E) along and in parallel to the surface of the mobile telephone 51 so as to choose one of the two positions (an image formable position and an image unformable position). The telephoto lens 53 makes a 90° turn around a support shaft 54 (as shown by a double headed arrow F) so as to choose one of the two positions (an image formable position and an image unformable position).

When it is desired to form an image with the wide-angle lens 52, the user manually raises the telephoto lens 53 by 90° to a position shown by a dotted line, whereby the wide-angle lens 52 is slid to the image formable position as will be described later. When it is desired to form an image with the telephoto lens 53, the telephoto lens 53 is set at the image formable position (position shown by a solid line), whereby the wide-angle lens 52 is slid to the image unformable position.

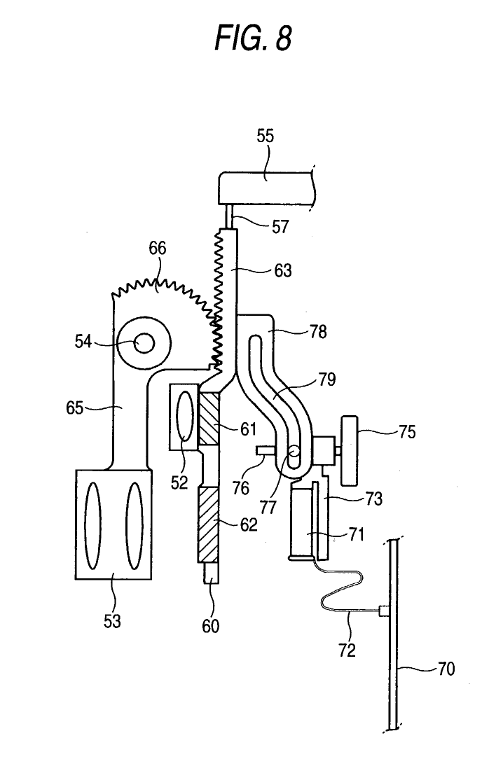

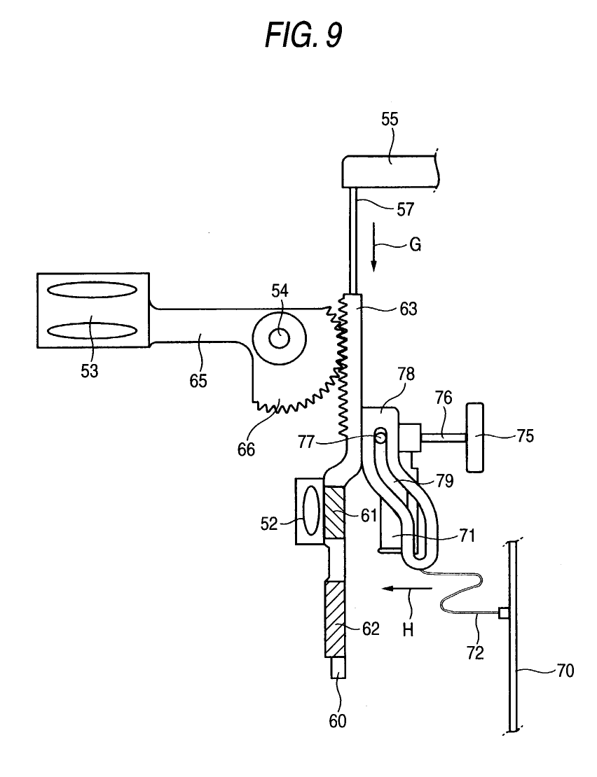

FIG. 7 is a perspective view of a camera portion having a lens moving mechanism and an image pickup element positioning mechanism that are installed in the mobile telephone 51 according to this embodiment of the invention; FIG. 8, a side view of the camera portion when the telephoto lens is used for forming images; and FIG. 9, a side view of the camera portion when the wide-angle lens is used for forming images.

A infrared-light cutting filter 61 and a visible-light cutting filter 62 are fixedly arranged side by side in the sliding direction on a filter holder 60 slidably provided on the surface of the body of the mobile telephone 51, the wide-angle lens 52 being fixedly arranged on the top of the infrared-light cutting filter 61.

The support member 55 of the filter holder 60 is fixed to the body of the mobile telephone 51 and the filter holder 60 is slidably supported along two holder supporting rails 56 and 57 extended from the support member 55. A long rack 63 is projected from the right end portion of the upper end portion (side end portion of the infrared-light cutting filter 61) of the filter holder 60 and the holder supporting rail 57 is inserted along the longer direction of the rack 63.

The support member 58 of the telephoto lens 53 is fixedly arranged in the body of the mobile telephone 51 and the support shaft 54 of the telephoto lens 53 is pivotally supported by the support member 58. Pivotal arms 65 extended from the frame body 59 of the telephoto lens 53 are coupled to the support shaft 54. A gear 66 rotating together with the support shaft 54 and the pivotal arms 65 and meshing with the rack 63 is provided in the right end portion of the support shaft 54. When the telephoto lens 53 is moved and rotated by 90° from the condition shown in FIG. 8 to what is shown in FIG. 9 or reversely moved and rotated thereby, the gear 66 causes the rack 63, that is, the filter holder 60 to slide along the holder supporting rails 56 and 57.

A board 70 loaded with a camera control circuit (not shown) and an iris-authentication processing circuit (not shown), and an image pickup element 71 are provided in the mobile telephone 51, both of the board 70 and the image pickup element 71 being connected by a flexible flat cable 72. The image pickup element 71 is mounted on an image pickup element holder 73.

The image pickup element holder 73 is supported by a support pin 76 so as to be slidable in the direction of the optical axis. The support pin 76 is projected from a support member 75 fixed to the interior of the mobile telephone 51 and extended in directions parallel to the optical axis when the telephoto lens 53 is set at the image formable position and to the optical axis of the wide-angle lens 52.

Further, the image pickup element holder 73 is formed integrally with a positioning pin 77 projecting laterally at 90° with the support pin 76. A guide rail 78 is provided integrally with the rack 63, the guide rail 78 extending in the same direction as the longer direction of the rack 63 on the back side of the tooth face meshing with the gear 66. The front end portion of the positioning pin 77 is inserted into a slot-like guide hole 79 provided in the guide rail 78.

The guide hole 79 is in the form of a crank meandering at a moderate angle and the positioning pin 77 inserted into the guide hole 79 moves longitudinally along the support pin 76 (in the direction along the optical axis) when the guide rail 78 moves in the longer direction together with the movement of the rack 63. The positioning pin 77 is placed at either image forming position with the wide-angle lens 52 or image forming position with the telephoto lens 53.

The operation of the mobile telephone 51 will now be described with reference to FIGS. 8 and 9.

When the user owning the mobile telephone 51 wants to pick up the user's iris image for processing the individual authentication, the condition shown in FIG. 8, that is, a condition with the pivotal arm 65 of the telephoto lens 53 being brought down is set. In this condition, the telephoto lens 53 and the visible-light cutting filter 62 are arranged in a row and simultaneously the visible-light cutting filter 62 and the image pickup element 71 are also arranged in a row. Moreover, the image pickup element 71 is placed by the positioning pin 77 at the image forming position of the telephoto lens 53.

Thus, a clear iris image by near infrared light is focused on the image pickup element 71 and the iris image for use in authenticating the individual is taken into the mobile telephone 51. Data on the characters of the iris is extracted from the iris image and processed for collating the extracted data on the characters thereof with data on the characters of the pre-registered user's iris. When both the data conform to each other, the mobile telephone 51 is made usable, whereas when both the data differ, the operation of inputting data to the mobile telephone 51 is made invalid.

When the user attempts to pick up a scenic image, the condition, shown in FIG. 9, is manually set by raising the pivotal arm 65 of the telephoto lens 53. When the pivotal arm 65 of the telephoto lens 53 is raised, the gear 66 together with the pivoting of the pivotal arm 65 and the support shaft 54 is rotated and the rack 63 meshing with the gear 66 is slid in the direction of an arrow G (FIG. 9 shows a condition in which the rack 63 has completely been slid in the direction of the arrow G).

Thus, the whole filter holder 60 is slid in the direction of the arrow G along the holder supporting rails 56 and 57 and the wide-angle lens 52 is placed exactly at the front position of the image pickup element 71, so that visible light is incident on the image pickup element 71 through the wide-angle lens 52 as well as the infrared-light cutting filter 61.

In the mobile telephone 51 according to this embodiment of the invention, on the other hand, the guide hole 79 of the guide rail member 78 is moved in the direction of the arrow G when the whole filter holder 60 is slid in the direction of the arrow G by raising the pivotal arm 65 of the telephoto lens 53 and the positioning pin 77 that is integral with and projected from the image pickup element holder 73 is slid in the direction of an arrow H of FIG. 9. The image pickup element 71 is placed at the image forming position of the wide-angle lens 52 and a clear visible image passed through the wide-angle lens 52 and the infrared-light cutting filter 61 is focused on the image pickup element 71 accordingly.

In the mobile telephone 51 according to this embodiment of the invention, one image pickup element 71 is thus allowed to take in different images through the wide-angle lens 52 and the telephoto lens 53 that are different in focal length via the respective cutting filters 61 and 62. Consequently, two cameras can be installed in the small body of the mobile telephone 51 less costly.

Therefore, it is possible to add an iris imaging telephoto lens and an iris authenticating function to the mobile telephone equipped with a wide-angle lens less costly and it is also facilitated to attempt to retain security in case where a mobile telephone is provided with a credit card function.

Although a description has been given of examples of taking in an iris image for use in individual authentication from the telephoto lens according to the above embodiments of the invention, the invention is not limited to taking in the iris image from the telephoto lens but may be applicable to taking in a retina image and an image of the contour of a face, for example. In this case, the most suitable filter, instead of the visible-light cutting filter, is employed, depending on the kind of the image taken in from the telephoto lens.

Further, though it has been arranged to raise the telephoto lens 53 by 90° when image formation is carried out with the wide-angle lens 52 according to the second embodiment of the invention, the invention is not limited to such an arrangement but may be reduced into practice by 180° turning the telephoto lens 53 around the support shaft 54, for example, to ensure that the telephoto lens 53 is withdrawn from within the angle of view of the wide-angle lens 52.

Still further, although not shown in the above embodiments, the control unit or the control circuit holds data on the characters of the registered iris, and permits the use of the mobile telephone when the control unit or the control circuit decides that the data on the characters of the iris obtained by reducing an iris image received as the enlarged image to an numeral conforms to the data on the characters of the registered iris and prohibits the use thereof when the control unit decides that the data on the characters of their is obtained thereby differs from the data on the characters of the registered iris.

According to the invention, both the camera function using the telephoto lens and what uses the wide-angle lens are utilizable with a simple construction and by obtaining iris images and so forth using the telephoto lens, mobile telephones having individual authenticating functions can be supplied less costly.

What is claimed is:

1. A mobile telephone arrangeable in a plurality of forms, comprising:
an image pickup unit for forming images; and
a switching unit for switching focal lengths toward the image pickup unit with the accompaniment of changing one form to another.

2. A mobile telephone comprising:
a first body;
a second body;
a hinge for foldably coupling the first body and the second body;
a wide-angle lens provided in the first body for obtaining a wide-angle image;
a telephoto lens provided in the first body for obtaining an enlarged image;
an image pickup unit is provided in the second body; and
a slide mechanism which allows the enlarged image to be input to the image pickup unit through the telephoto lens if the mobile telephone is folded, and which slides the image pickup unit in response to the pivotal action of the hinge mechanism when the first body and the second body are unfolded to allow the wide-angle image to be input to the image pickup unit through the wide-angle lens.

3. The mobile telephone as claimed in claim 2, further comprising a visible-light cutting filter juxtaposed to the telephoto lens.

4. The mobile telephone as claimed in claim 2, wherein the slide mechanism comprises a pinion rotating as the hinge mechanism pivots and a rack member sliding as the pinion rotates.

5. The mobile telephone as claimed in claim 2, wherein the slide mechanism comprises a first stopper member for stopping the image pickup unit in the optical axis position of the telephoto lens and a second stopper member for stopping the image pickup unit in the optical axis position of the wide-angle lens.

6. The mobile telephone as claimed in claim 2, further comprising:
a control unit for holding data on the characters of the registered iris, permitting the use of the mobile telephone when the control unit decides that the data on the characters of the iris obtained by reducing an iris image received as the enlarged image to an numeral conforms to the data on the characters of the registered iris and prohibiting the use thereof when the control unit decides that the data on the characters of the iris obtained thereby differs from the data on the characters of the registered iris.

7. The mobile telephone as claimed in claim 6, further comprising a lock mechanism for unfolding the first body and the second body when the control unit permits the use of the mobile telephone.

8. A mobile telephone comprising:
a wide-angle lens;
a telephoto lens;
an image pickup element;
a lens moving mechanism for lining up the image pickup element and the wide-angle lens when image formation is conducted through the wide-angle lens, and for lining up the image pickup element and the telephoto lens when the image formation is conducted through the telephoto lens; and
an image pickup element positioning mechanism for placing the image pickup element at the image forming position of the wide-angle lens when the image formation is conducted through the wide-angle lens and placing the-image pickup element at the image forming position of the telephoto lens when the image formation is conducted through the telephoto lens.

9. The mobile telephone as claimed in claim 8 further comprising an authenticating unit which allows the use of the mobile telephone only when the data on the characters of the iris out of the iris image taken in from the telephoto lens conforms to the data on the characters of the registered iris.
